(19) United States
(12) Patent Application Publication
(10) Pub. No.: US 2026/0329602 A1
(43) Pub. Date: Oct. 22, 2026

(54) GENERATING A CUSTOM GRAPHICAL USER INTERFACE

(71) Applicant: GOOGLE LLC, Mountain View, CA (US)

(72) Inventors: Donny Chen Reynolds, Mountain View, CA (US); Yuncheng Shen, Sunnyvale, CA (US); Mehrab Norouzitallab, Frenchs Forest (AU); Darren Shen, Waitara (AU); John Henry Charles Palmer, North Sydney (AU); David-Jordi Vallet Weadon, Leichhardt (AU)

(21) Appl. No.: 19/653,699

(22) Filed: Apr. 21, 2026

Related U.S. Application Data
(60) Provisional application No. 63/792,741, filed on Apr. 22, 2025.

(51) Int. Cl. G06F 9/451; G06F 40/205; G06F 40/40

(52) U.S. Cl. CPC G06F 9/451; G06F 40/205; G06F 40/40

(57) ABSTRACT

A method includes receiving a request from a user to generate a custom graphical user interface (GUI) for a task; in response to receiving the request, using a model to generate a custom GUI by generating a GUI template based on the task, the GUI template including an interface element; retrieving data from a computing source, the data being selected based on the interface element and the task; and generating the custom GUI by populating the interface element of the GUI template based on the data; and presenting the custom GUI to the user.

### CROSS REFERENCE TO RELATED APPLICATION

This Application claims the benefit of priority based on U.S. Provisional Application No. 63/792,741, filed Apr. 22, 2025, the disclosure of which is hereby incorporated by reference.

### BACKGROUND

Graphical user interfaces enable users to easily navigate and select options available within a computing system. However, a given computing system may not have a graphical user interface available that suits a given user’s needs.

### SUMMARY

A computing system receives a textual input indicating a functional request for a graphical user interface (GUI) to facilitate a specific task. In response to the request, the computing system can generate a graphical user interface template based on the technical requirements inferred from the text input. The GUI template can include unpopulated interface elements (e.g., data containers or functional proxies) that do not initially have content. The computing system can retrieve data from one or more computing sources, which can be remote computing sources or a local source of data on the computing system. The computing system can select the data based on the text input and/or GUI template. The computing system can populate the interface elements based on the retrieved data. The computing system thereby generates a task-specific GUI with functional controls and UI elements mapped directly to the functional requirements for the requested task.

According to an example, a method includes receiving a request from a user to generate a graphical user interface (GUI) for a task; in response to receiving the request, using a model to generate the GUI by generating a GUI template based on the task, the GUI template including an interface element; retrieving data from a computing source, the data being selected based on the interface element and the task; and generating the GUI by populating the interface element of the GUI template based on the data; and presenting the GUI to the user.

According to an example, a non-transitory computer-readable storage medium comprises instructions stored thereon. When executed by at least one processor, the instructions are configured to cause a computing system to receive a request from a user to generate a graphical user interface (GUI) for a task; in response to receiving the request, use a model to generate the GUI by generating a GUI template based on the task, the GUI template including an interface element; retrieving data from a computing source, the data being selected based on the interface element and the task; and generating the GUI by populating the interface element of the GUI template based on the data; and present the GUI to the user.

According to an example, a computing system comprises at least one processor and a non-transitory computer-readable storage medium comprising instructions stored thereon. When executed by at least one processor, the instructions are configured to cause the computing system to receive a request from a user to generate a graphical user interface (GUI) for a task; in response to receiving the request, use a model to generate the GUI by generating a GUI template based on the task, the GUI template including an interface element; retrieving data from a computing source, the data being selected based on the interface element and the task; and generating the GUI by populating the interface element of the GUI template based on the data; and present the GUI to the user.

The details of one or more implementations are set forth in the accompanying drawings and the description below. Other features will be apparent from the description and drawings, and from the claims.

### BRIEF DESCRIPTION OF THE DRAWINGS

FIG. 1 shows a computing system generating a customized graphical user interface based on text input.

FIG. 2 shows multiple graphical user interface templates available for selection based on the text input.

FIG. 3 shows modification of a graphical user interface template.

FIG. 4 shows a block diagram of a computing system that can generate a customized graphical user interface based on text input.

FIG. 5 is a flowchart showing a method of generating a graphical user interface.

Like reference numbers refer to like elements.

### DETAILED DESCRIPTION

Computing systems can utilize structured interfaces to facilitate the execution of complex functional controls. A graphical user interface (GUI) can be a computer-generated visual representation of data and functional controls comprising a spatial arrangement of interactive graphical elements—such as icons, windows, and widgets—rendered on a display device to facilitate command execution within a computing system. A technical problem with GUI interaction is that static GUIs stored in memory may lack the specific functional mappings required for dynamically retrieved datasets or transient tasks. A technical solution to this technical problem is to programmatically synthesize a GUI at runtime that provides the specific functional controls indicated by a textual input. A dynamically generated GUI is a GUI structure that is instantiated in volatile memory in response to a specific trigger. By determining the structure and content in response to a request, the system avoids the computational overhead and storage requirements of maintaining a library of rarely-used, static interfaces. The GUI can be generated by generating a GUI template, retrieving data from one or more remote computing sources, and populating the GUI template with the retrieved data. A technical benefit of this technical solution is the dynamic allocation of interface resources and the reduction of interface-to-task latency by providing high-specificity control mappings.

From the perspective of the computing system, a technical problem arises when the available graphical user interface (GUI) assets—which can be static, pre-compiled resource files—possess a fixed schema that cannot map to the variable functional requirements of a user’s natural language request. This results in a state where the system has the processing capacity to perform a task but lacks the visual orchestration layer to facilitate user interaction. A technical solution to this technical problem is the programmatic synthesis of a dynamic GUI. This process involves a multi-stage execution pipeline: first, a generative model transforms textual intent into a set of functional requirements; second, a template selector identifies or constructs a spatial layout with unpopulated data containers; and third, a template populator resolves data dependencies by mapping retrieved machine-readable values to these containers at runtime. At least one technical benefit of this technical solution is the elimination of the requirement for pre-defined UI assets, allowing the system to achieve state-aware interface generation that is directly coupled to the specific data schema of the retrieved content.

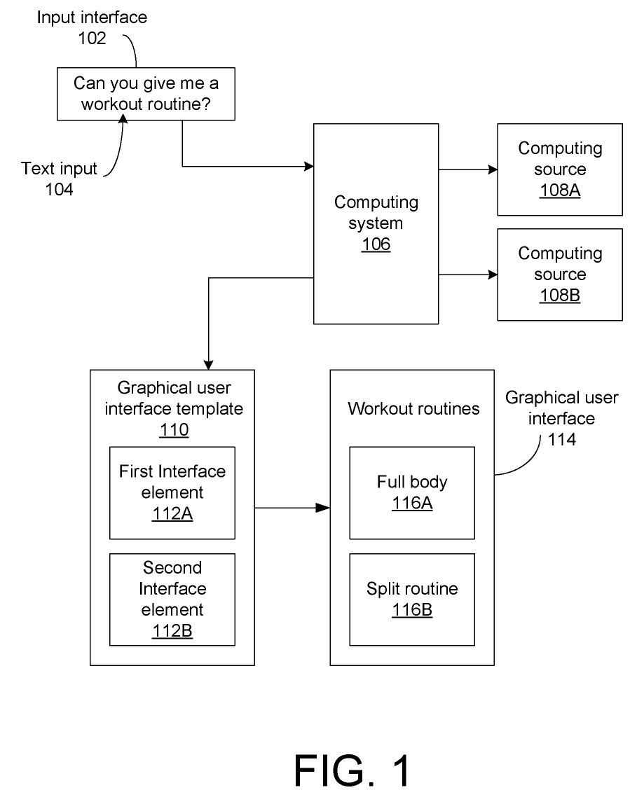

FIG. 1 shows an example workflow for a computing system 106 generating a customized graphical user interface (GUI) 114 based on text input 104. A customized graphical user interface or custom graphical user interface can include a unique visual layout where the selection, arrangement, and functional properties of interface elements are programmatically synthesized at runtime to correspond to a specific data-driven task. By programmatically synthesizing the GUI, the system can adapt the visual layout to the specific schema of retrieved data, ensuring that all retrieved functional parameters are mapped to an interactive element. Features described herein can be implemented by an operating system executing on the computing system 106.

The computing system 106 can present an input interface 102 to the user. The input interface 102 can receive text input, such as text input 104, from the user. The input interface 102 can be included in a command-line interface, or can be a component of a GUI, as non-limiting examples. In some implementations, the input interface 102 is a command line interface within an operating system environment executing on the computing system 106. In some implementations, the input interface 102 is a field presented by a web browser. In some implementations, the input interface 102 is an audio input interface. For example, rather than receiving text input via a text interface, the computing system 106 can receive speech from a user and translate the speech to text. In some implementations, the computing system 106 can generate a description of the user intent based on activity of the user, such as web browsing activity, text received by the computing system 106 via various fields implemented by the computing system 106, or interactions with applications executing on the computing system 106, as non-limiting examples.

The computing system 106 can interpret the text input 104 as a request for a graphical user interface with a requested feature or that accomplishes a specific task or goal. In some implementations, the computing system 106 implements and/or accesses a language model to interpret the text input 104. A request can be a data signal or sequence of characters received via an input interface that specifies a desired task to be facilitated by the computing system. The language model can, for example, determine an intent of the user and/or a task to be performed based on the text input 104. A task can include a computing objective or set of operations.

In the example shown in FIG. 1, the text input 104 is, “Can you give me a workout routine?” The computing system 106 can determine, based on the text input 104, that an intent of the user is for a GUI that presents one or more physical exercise programs.

The computing system 106 can retrieve data for generating a GUI from computing sources, such as computing sources 108A, 108B. Data can include machine-readable values selected based on a determined user task that provides the substantive content and functional instructions for populating a GUI. The computing sources 108A, 108B can be remote computing sources with which the computing system 106 communicates via a network such as the Internet, or local sources of data such as memory stored on and/or available to the computing system 106. The computing system 106 can determine the computing sources from which to retrieve the data based on the text input 104 and/or based on intent determined based on the text input 104. In some implementations, the computing system 106 generates a search query for a search engine based on the text input 104 and/or intent or task determined based on the text input 104. The data retrieved from the at least one computing source can include text and/or images. The at least one computing source can include, for example, a server such as a webserver that maintains a website from which the computing system 106 retrieves the data.

The computing system 106 can generate a GUI template 110. A GUI template can include a digital layout specification that can include a predefined spatial arrangement of unpopulated interface containers. In some implementations, each container in the GUI template 110 is associated with specific data types or functional attributes.

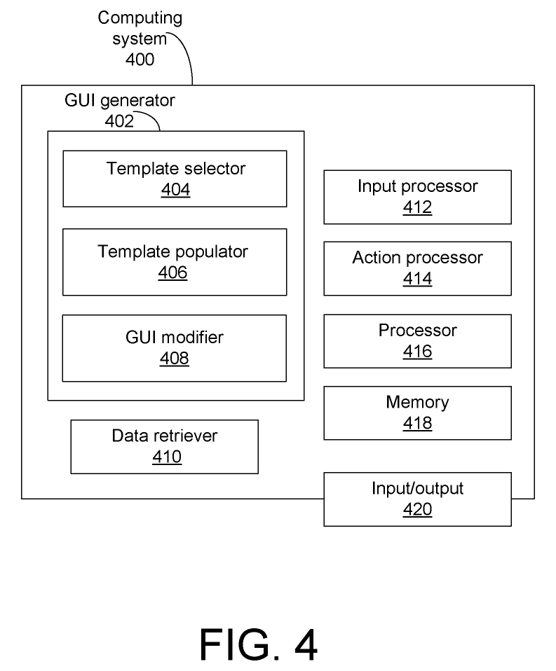

The computing system 106 can generate the GUI template 110 based on the text input 104 and/or the task determined by the text input 104. The computing system 106 can, for example, generate the GUI template 110 based on a number of buttons, icons, windows, or other interface elements needed to accomplish the task of the user as indicated by the text input 104. A generative model can, for example, determine a number of interface elements needed for the task indicated by the text input 104 and generate the GUI template 110 based on the determined number of interface elements. An interface element can be a discrete, interactive component of a graphical user interface that serves as a visual proxy for a computing function, configured to both display data and capture user-initiated events. In some implementations, the computing system 106 generates the GUI template 110 by selecting the GUI template 110 from multiple previously-generated GUI templates. In some implementations, a template selector 404 (shown in FIG. 4) included in a GUI generator (shown in FIG. 4) selects the GUI template 110. The previously-generated GUI templates may have been generated for use by the same user or multiple users. The previously-generated GUI templates may have been developed for the purpose of creating custom GUIs, or by removing content from previous GUIs.

The GUI template 110 can have blank elements. For example, the GUI template 110 can have blank elements that can be populated by images and/or text. The GUI template 110 can have blank interface elements 112A, 112B. The blank interface elements can be user interface elements that will, when populated, present an image and/or text, such as icons or menu items, and receive input from the user such as a selection (based on a click or tap) or text entry. The blank interface elements can have values that will be replaced by values based on the data from the computing sources 108A, 108B to populate the GUI template 110 and generate the customized GUI 114. The values, before replacement, can cause the interface elements 112A, 112B to present solid colors, such as white, or can include any values. The values of the blank interface elements 112A, 112B can be populated by the computing system 106 based on the data received from the remote computing sources 108A, 108B.

The computing system 106 can generate a customized GUI 114 by populating the interface elements 112A, 112B of the GUI template 110 based on the data retrieved from the remote computing sources 108A, 108B. Populating can include a process of resolving data dependencies for interface elements by replacing non-functional placeholder values with task-specific content strings and image assets that are included in the retrieved data. In some implementations, the GUI is a web application running in a tab of a browser. In some implementations, the computing system 106 can add a control for launching the custom GUI to a virtual workspace of an operating system executing on a computing system. The virtual workspace can include any operating system environment that presents app icons used to launch apps to a user, such as a desktop, a home screen, a task bar, or an applications list interface, as non-limiting examples.

In some implementations, a template populator 406 (shown in FIG. 4) included in the GUI generator 402 populates the interface elements 112A, 112B of the GUI template 110. The computing system 106 can, for example, select icons, text, images, or other content based on the data for each of the blank interface elements 112A, 112B. The computing system 106 can match the content (such as icons, text, and/or images) to the GUI template 110 to determine how to populate the GUI template 110 with the content. In the example shown in FIG. 1, in which the text input 104 included “Can you give me a workout routine?,” the customized GUI 114 includes text, “Workout routines.” The text is generated by a generative model optimized to generate user interfaces based on text input, such as the text input 104. The text can be a summary or overview of the text input 104. The generative model can be included in and/or implemented by the GUI generator 402. In the example shown in FIG. 1, a first blank interface element 112A of the GUI template 110 has been populated based on the retrieved data to generate a first customized interface element 116A with text or an image indicating that selection of the first customized interface element 116A will cause the customized GUI 114 to present a “Full body” workout. In the example shown in FIG. 1, a second blank interface element 112B of the GUI template 110 has been populated based on the retrieved data to generate a second customized user interface element 116B with text or an image indicating that selection of the second customized user interface element 116B will cause the customized GUI 114 to present a “Split routine” workout. The computing system 106 can respond to selection of the first customized interface element 116A or second customized interface element 116B by presenting additional images and/or interfaces based on the data retrieved from the remote computing sources 108A, 108B.

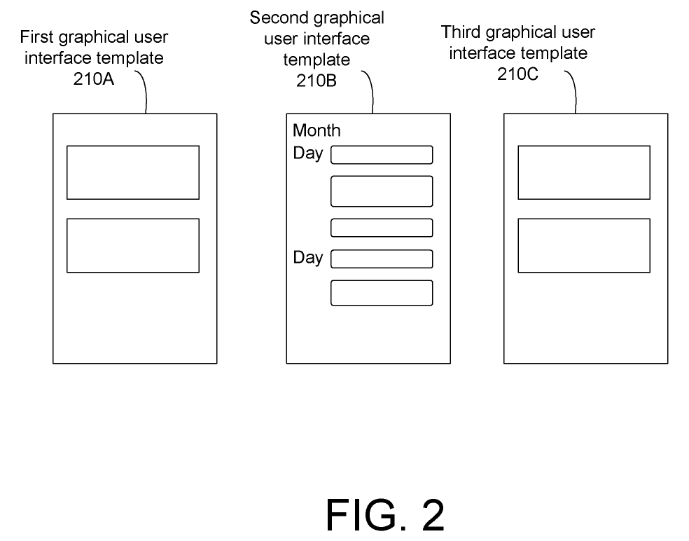

FIG. 2 shows multiple GUI templates 210A, 210B, 210C available for selection based on the text input 104. The GUI templates 210A, 210B, 210C are examples of the GUI template 110. The GUI templates 210A, 210B, 210C available for selection can be considered multiple potential GUI templates. The potential GUI templates may have been developed for the purpose of creating custom GUIs, or by removing content from previous GUIs. The computing system 106 and/or template selector 404 can select one of the GUI templates 210A, 210B, 210C based on the text input 104 and/or intent or task determined based on the text input 104. A generative model implemented by the computing system 106 and/or template selector 404 can determine which of the GUI templates 210A, 210B, 210C to select by calculating a technical fit between the template structure and the task requirements. In some implementations, the GUI templates 210A, 210B, 210C are stored on the computing system 106 and loaded into main memory based on the text input 104. In some implementations, the computing system 106 retrieves one of the GUI templates 210A, 210B, 210C from a remote computing source based on the text input 104.

In the example shown in FIG. 2, a first GUI template 210A includes two interface elements (not labeled). The interface elements can be populated with text or images. The computing system 106 can respond to selection of the interface elements of the GUI template 210A by presenting additional information based on the data retrieved from the computing source(s) 108A, 108B.

In the example shown in FIG. 2, a second GUI template 210B is a calendar GUI. The calendar GUI of the second GUI template 210B includes a field that can be filled with a month, fields that can be filled with days of the month, and fields that can be filled with activities or tasks to be performed at specified times during the day. The computing system 106 can populate the month, days, and/or activities based on the data retrieved from the remote computing source(s) 108A, 108B and/or based on input received from the user.

In the example shown in FIG. 2, a third GUI template 210C is a blank GUI. The computing system 106 can populate the blank GUI of the third GUI template 210C with text and/or one or more images based on the data retrieved from the computing source(s) 108A, 108B and/or based on input received from the user.

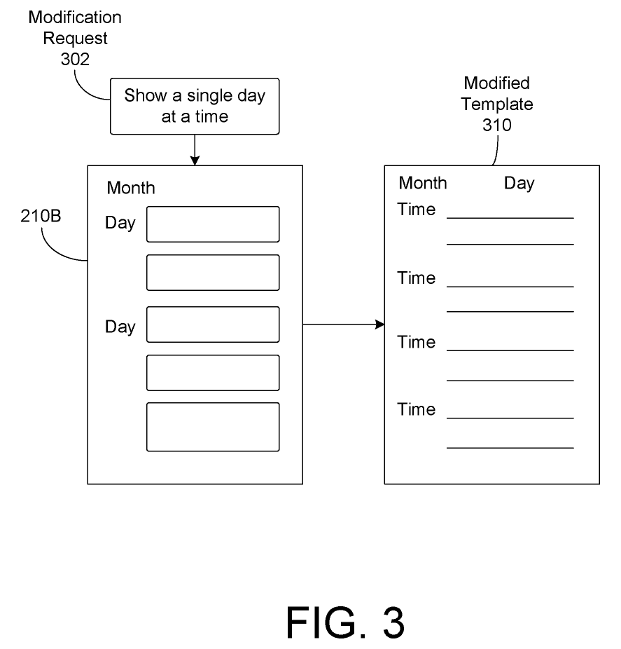

FIG. 3 shows modification of the GUI template 210B. After generation and/or selection of a GUI template, such as the calendar template of the second GUI template 210B, the computing system 106 can receive a request from the user to modify the GUI template. The computing system 106, and/or a GUI modifier 408 (shown in FIG. 4) included in the GUI generator 402, can respond to the request to modify the GUI template by rearranging, adding, and/or removing elements of, to, or from the GUI template.

In the example shown in FIG. 3, the computing system 106 receives a modification request 302 from the user. The modification request 302 in the example of FIG. 3 is text, “Show a single day at a time,” inputted to the computing system 106 by the user. The computing system 106 and/or GUI modifier 408 determines the intent or goal of the modification request 302, such as by implementing or accessing a language model.

Based on the modification request 302, the computing system 106 determines that the functional requirements of the task have changed from a multi-temporal view to a single-temporal view, e.g., the calendar GUI template (GUI template 210B) to display times and activities of a single day, rather than multiple days. Based on this technical determination, the computing system 106 generates a modified template 310. The modified template 310 updates the spatial arrangement to represent data associated with a single day of a single month, and includes multiple timestamps and corresponding task identifiers (e.g., activities or tasks to be performed) with those timestamps.

FIG. 4 shows a block diagram of a computing system 400 that can generate a customized graphical user interface based on text input. The computing system 400 can implement any combination of features described above with respect to the computing system 106. In some implementations, the features can be performed and/or implemented by an operating system executing on the computing system 400. The methods, functions, and/or techniques described herein as being performed by the computing system 400 can be performed by a computing device with which the user is interacting, such as a smartphone, extended reality headset, laptop or notebook computing device, smart TV, desktop computing device, or a tablet computing device, by a remote server or other computing device in communication with the computing device with which the user is interacting, or distributed between multiple such computing devices, as non-limiting examples.

The computing system 400 can implement a generative model. The computing system 400 can apply the generative model to generate a customized GUI, such as the customized GUI 114, based on a user request for a GUI to accomplish a task. The text input 104 is an example of the user request. Generative models are large deep learning models with multiple layers and a high number of parameters that learn the probability distribution of underlying data. In some cases, such models are pre-trained on vast amounts of data and/or using few-shot learning techniques. Such models take in a prompt, which can include a request (query such as the text input 104) and context (such as interaction history) used to generate a response to the query. Such models can generate images from a prompt, can generate answers about a body of text, can generate code, can summarize text, describe an image, etc. A generative model may include a set of neural networks that consist of an encoder and a decoder with self-attention capabilities. The encoder and decoder extract meanings from a sequence of text and understand the relationships between words and phrases in it. The generative model can receive and process input, such as the text input 104, to determine the task that the user desires to accomplish or perform with the GUI. The generative model can be used by a GUI generator 402 to generate the GUI to accomplish the task. In some implementations, the GUI generator 402 is implemented by the operating system executing on the computing system 400.

The GUI generator 402 can identify a task type and associated parameters by executing a semantic parsing operation on the text input 104. A task type can include a classification of a user request. The GUI generator 402 can identify the task type by parsing the text input 104 to determine a functional objective represented by the request. In some implementations, the generative model identifies parameters and task types to match the text input 104 with the appropriate template. For example, in the request, “Can you give me a workout routine for 30 minutes?”, the model parses the task type as “content retrieval” or “scheduling” and identifies “30 minutes” as a temporal parameter. The model then maps these extracted parameters to a predefined schema or ontology of tasks supported by the computing system 400. This parsing stage can ensure that the natural language is converted into a machine-readable format where the task type dictates the logic of the GUI template selection and the parameters dictate the scope of the data retrieval.

The GUI generator 402 can include a template selector 404. The template selector 404 can select a blank GUI template, such as any of the GUI templates 110, 210A, 210B, 210C, based on text input from a user, such as the text input 104. The text input can include a request by the user to generate a custom GUI for a task. The template selector 404 can use a model, such as a generative model, to determine the task based on the text input and choose a GUI template based on the text input. Put another way, the template selector 404 can be or can call a generative model that has been trained to take text input and output a GUI template suitable for accomplishing a task represented by the text input. The task can include a goal of the text input, or what action the user desires the computing system 400 to perform, such as a type of GUI that the user desires the computing system 400 to present to the user. This task or goal informs the template chosen (selected or generated) by the language model to complete the task.

In some implementations, and with user consent, the template selector 404, e.g., using the model, determines the GUI template based on the text input and an interaction history of a user who provided the text input or request. The interaction history can include applications on the computing system 400 opened by the user, browser tabs open in a browser application, input into the applications, or web browsing history, as non-limiting examples. The interaction history of the user can resolve ambiguity in the text included in the request. For example, if a user inputs, “open my routine,” the GUI generator can determine whether “my routine” refers to a “workout routine” or a “coding routine” based on the interaction history of the user. The GUI generator 402 can determine which portions of the interaction history are relevant to the task or goal. Thus, the user interaction history can inform the GUI template and/or custom GUI chosen by the template selector 404.

The computing system 400 can implement a generative model configured as a multi-stage orchestration engine. The computing system 400 can apply the generative model to generate a customized GUI, such as the customized GUI 114, by executing a pipeline that transforms the text input 104 into a set of functional requirements. Generative models used herein may include large language models (LLMs) or transformer-based architectures with self-attention capabilities. In some implementations, the generative model operates by parsing the text input 104 to identify a task type and associated parameters, generating a structured query for a data retriever 410 based on the identified parameters, and/or selecting or synthesizing a GUI template 110 that possesses a GUI compatible with the data types expected from the data retriever 410. For example, if the text input 104 specifies a “comparison” task, the model selects a template with a multi-column spatial arrangement, whereas a “sequential” task triggers a linear layout. The technical fit between the template and the functional requirements and/or task requirements can be calculated by a scoring engine that considers factors such as evaluating a compatibility matrix between the metadata of available templates—such as the number and data-type constraints of unpopulated containers; structural parity, representing the degree of match between the number of required data fields and available UI containers; semantic alignment, representing the degree of match between the data types (e.g., boolean, string, image-url) required by the task and the input constraints of the template; and/or the cardinality and format of the data returned by the structured query. A high technical fit score can be assigned when the template provides a one-to-one mapping for a high number of (or all) functional requirements and/or task requirements identified based on the text input 104. A low technical fit score can be assigned when the template satisfies few or no functional requirements and/or task requirements identified based on the text input 104.

The template selector 404, via the generative model, can select the blank GUI template that is most likely to achieve the task represented by the text input (such as a GUI template 110 that possesses a GUI compatible with the data types expected from the data retriever 410). In some implementations, the template selector 404 selects the blank GUI template based on both the task and the data retrieved based on the task. To determine which templates are most likely to assist the user, the generative model can perform a semantic similarity analysis, encoding the text input 104 into a high-dimensional vector and comparing the high-dimensional vector against vector representations of template metadata. In some implementations, the template selector 404 applies a ranking algorithm that weights potential templates based on a combination of the proximity of functional attributes of the template to inferred user intent and/or historical success metrics associated with the interaction history of the user, where templates that previously led to successful task completion for similar inferred user intents are prioritized. In some implementations, the template selector 404 selects the blank GUI template based on both the task and the data retrieved based on the task. In some implementations, the blank GUI templates available to the template selector 404 for selection are stored on the computing system 400. In some implementations, the blank GUI templates are included in the data retrieved by the computing system 400 from one or more computing sources such as the computing sources 108A, 108B. In some implementations, the computing system 400 retrieves a single blank GUI template from a computing source based on the text input processed by the GUI generator 402 and/or the intent or task determined by the GUI generator 402.

In some implementations, the template selector 404 selects the GUI template 110 from a library of available templates by executing a schema-matching heuristic that calculates a compatibility match (or compatibility) between the template and the results of the structured query. In some implementations, each template in the library is associated with metadata defining a structural schema, including the number of available interface containers and the specific data types (e.g., image-resource, plaintext, boolean) each container is configured to render. The template selector 404 compares this template schema against the data types and cardinality of the retrieved data structure returned by the structured query. A compatibility match is identified when the template schema provides a structural mapping for each discrete data field in the returned payload. For example, if the structured query returns an array of five exercise objects, the template selector 404 prioritizes templates with at least five data-binding containers. This technical matching process ensures that the selected template possesses the necessary visual architecture to represent the full dimensionality of the retrieved content without data loss or UI overflow.

The blank GUI template can include one or more interface elements. The interface elements can include buttons, text fields, drop-down menus, or slide bars, as non-limiting examples. In some implementations, the computing system 400 responds to selections or other input to the interface elements by presenting additional interface elements. In some implementations, the computing system 400 responds to selections or other input to the interface elements by presenting images and/or text populated into the GUI by a template populator 406.

The GUI generator 402 can include the template populator 406. In some implementations, the template populator 406 populates a blank GUI template based on data retrieved from one or more computing sources. The template populator can retrieve the data in response to a request by a language model in communication with the template populator 406 and/or computing system 400, from a set of retrieved results of a request for data, a separate computing system that accesses data for populating the GUI template via tooling, or agentic mechanisms. The computing sources can be remote computing sources that the computing system communicates with via a network such as the Internet, or local memory stored on and/or accessible to the computing system 400. In some implementations, the template populator 406 populates a GUI that has been modified and/or customized by a GUI modifier 408 based on data retrieved from one or more remote computing sources. The template populator 406 can populate a GUI (either a blank GUI template or customized GUI) with text and/or images based on the data, as non-limiting examples. The template populator 406 can select the text and/or images with which to populate the GUI based on the text input processed by the GUI generator 402 and/or the intent or task determined by the GUI generator 402 based on the text input. The template populator 406 can, for example, populate interface elements within the GUI with the text and/or images. The text and/or images populated into the interface elements by the template populator 406 can indicate the purpose and/or function of the interface elements.

In some implementations, the template populator 406 populates a blank GUI template by performing a schema-matching operation between the retrieved data and the metadata fields of the interface elements. The template populator 406 can retrieve the data in response to a request by a language model or through an agentic mechanism that executes specific tools or APIs. For example, the template populator 406 may invoke an API at runtime to retrieve data for populating the GUI. This population process may further include dynamic resizing of interface elements based on the volume of retrieved text or the resolution of retrieved images to prevent interface overflow, thereby maintaining the functional integrity of the GUI layout at runtime. The template populator 406 can, for example, populate interface elements within the GUI with the text and/or images. The text and/or images populated into the interface elements by the template populator 406 can indicate the purpose and/or function of the interface elements.

The GUI generator 402 can include a GUI modifier 408. The GUI modifier 408 can modify a blank GUI template to generate a customized GUI. In some implementations, the GUI modifier 408 modifies the blank GUI template based on the initial text input, task determined based on the initial text input, and/or intent or task determined based on the initial text input based on which the template selector 404 selected the blank GUI template. In some implementations, the GUI modifier 408 modifies the blank GUI template based on text input processed subsequently to the initial text input and/or an intent or task determined subsequently to the intent or task based on which the template selector 404 selected the blank GUI template. The GUI generator 402 can determine a semantic meaning and/or intent or task of the text input processed subsequently to the initial text input. In some implementations, the GUI modifier 408 rearranges elements within the blank GUI template based on the semantic meaning and/or intent to generate the customized GUI. In some implementations, the GUI modifier 408 rearranges the elements by moving, enlarging, or reducing the sizes of the elements. In some implementations, the GUI modifier 408 increases or decreases a number of interface elements in the blank GUI template. In some implementations, the GUI modifier 408 removes some elements of the blank GUI template and/or retrieves elements from other blank GUI templates and adds the retrieved elements to the blank GUI template to generate the customized GUI template.

In some implementations, the GUI modifier 408 executes a differential layout synthesis to resolve a modification request 302. This process involves the generative model performing a semantic delta analysis (difference determination) between the current state of the customized GUI 114 and the intent of the modification request 302 to identify specific structural variances, determining a difference between the current state of the customized GUI 114 and the intent of the modification request 302. For example, if a modification request 302 specifies “show a single day at a time,” the GUI modifier 408 identifies a transformation from a multi-entity grid schema to a high-detail single-entity schema based on the difference between the current state of the customized GUI 114 and the intent of the modification request 302. The GUI modifier 408 then programmatically adjusts the spatial arrangement by reallocating display coordinates, resizing unpopulated interface containers, or adding supplemental data fields (e.g., time slots) that were not present in the initial template, based on the transformation and/or determined difference. This can ensure that the modification is not merely a filter of existing data, but a structural adaptation of the visual architecture to meet the evolving functional requirements of the user's task.

In some implementations, the GUI generator 402 generates the GUI template by executing a joint task-data synthesis. In this process, the generative model first identifies a primary UI archetype (e.g., a dashboard, a list, or a conversational flow) based on the task type inferred from the text input 104. The generative model can also analyze the metadata of the data retrieved by the data retriever 410 to determine a required container cardinality and a set of data-type constraints. The generative model then synthesizes the GUI template by populating the primary UI archetype with a specific number of interface elements that correspond to the discrete entities found in the retrieved data. For example, if the task is ‘comparison’ and the retrieved data contains three distinct objects, the model generates a template with a three-column grid. This can ensure that the visual architecture is not only semantically relevant to the task of the user, but also structurally optimized for the specific dimensions of the retrieved information payload.

The computing system 400 can include a data retriever 410. The data retriever 410 can retrieve data from remote computing sources, such as the remote computing sources 108A, 108B. The data retriever 410 can retrieve the data from the remote computing sources via a network such as the Internet. The data retriever 410 can retrieve the data based on the input text processed by the GUI generator 402 and/or the intent or task determined by the GUI generator 402. In some implementations, the data retrieved by the data retriever 410 includes one or more blank GUI templates available for selection by, and/or selected by, the template selector 404. In some implementations, the data retrieved by the data retriever 410 includes text and/or data with which the template populator 406 populates a GUI and/or interface elements within the GUI.

In some implementations, the computing system 400 implements a recursive validation loop where the data retriever 410 compares the schema of the retrieved data against the input constraints of the selected GUI template. If a schema mismatch is detected—such as a mismatch in data cardinality or incompatible data types—the data retriever 410 can trigger a secondary retrieval operation or signal the GUI modifier 408 to adjust the template structure at runtime to maintain data parity. This can ensure that the generated GUI remains functional even when the retrieved content is unstructured or highly variable. In some implementations, the data retriever 410 calls an application programming interface (API), such as a search engine API. The data retriever 410 can select the API to call based on the text input processed by the GUI generator 402 and/or the intent or task determined by the GUI generator 402. In some implementations, the data retriever 410 includes the text input and/or intent or task as a parameter in the API call. In some implementations, the data retriever 410 is implemented by the operating system executing on the computing system 400.

The data retriever 410 can select the data to retrieve, and/or the remote computing sources from which to retrieve the data, based on the text input processed by the GUI generator 402 and/or intent or task determined by the GUI generator 402. In some implementations, the data retriever 410 retrieves the data by providing the text input as a search query to a search engine (such as an Internet search engine), and retrieving the data identified by the search engine. In some implementations, the data retriever 410 calls an application programming interface (API), such as a search engine API. The data retriever 410 can select the API to call based on the text input processed by the GUI generator 402 and/or the intent or task determined by the GUI generator 402. In some implementations, the data retriever 410 includes the text input and/or intent or task as a parameter in the API call. In some implementations, the data retriever 410 is implemented by the operating system executing on the computing system 400.

The computing system 400 can include an input processor 412. The input processor 412 can process input received by the computing system 400 from the user after the GUI generator 402 has generated the GUI. The input processor 412 can process selections of, and/or input into (such as text input into), the interface elements. In some implementations, the input processor 412 can process a selection of a button or icon by a click or tap on the button or icon. In some implementations, the input processor 412 can process input, such as text input, into an interface element. In some implementations, the input processor 412 is implemented by the operating system executing on the computing system 400. The input processor 412 can, for example, interface with input/output devices (such as the input/output node 420).

The computing system 400 can include an action processor 414. The action processor 414 can process, and/or cause the computing system 400 to perform, actions based on inputs processed by the input processor 412. In some implementations, the action processor 414 can cause the computing system 400 to present additional content such as text and/or images in response to selection of or input into an interface element. In some implementations, the action processor 414 can cause the computing system 400 to present an additional interface element in response to selection of or input into an interface element. In some implementations, the computing system 400 maintains a state-aware session for the custom GUI, where user interactions processed by the input processor 412 are inputted back into the generative model as contextual metadata. Inputting the user interactions back into the generative model as contextual metadata allows the GUI generator 402 to perform iterative refinement of the interface, such as adding new interface elements or modifying existing spatial arrangements based on the user's observed interaction patterns within the session. In some implementations, the action processor 414 is implemented by the operating system executing on the computing system 400.

In some implementations, the computing system 400 can delete the custom GUI in response to the input processor 412 processing the input received via the custom GUI. In some implementations, the computing system 400 can delete the custom GUI in response to the action processor 414 performing the action based on input to the input processor 412. In some implementations, the computing system 400 can delete the GUI after a predetermined time has elapsed since the input processor 412 processed input received via the custom GUI. In some implementations, the computing system 400 can delete the GUI after a predetermined time has elapsed since the action processor 414 performed an action based on input processed by the input processor 412 based on input received via the custom GUI. A technical benefit of deleting the custom GUI after the custom GUI is no longer being used is freeing memory resources within the computing system 400.

The computing system 400 can include at least one processor 416. The at least one processor 416 can execute instructions, such as instructions stored in at least one memory device 418, to cause the computing system 400 to perform any combination of methods, functions, and/or techniques described herein. The operating system can be executed by the at least one processor 416.

The computing system 400 can include at least one memory device 418. The at least one memory device 418 can include a non-transitory computer-readable storage medium. The at least one memory device 418 can store data and instructions thereon that, when executed by at least one processor, such as the processor 416, are configured to cause the computing system 400 to perform any combination of methods, functions, and/or techniques described herein. Accordingly, in any of the implementations described herein (even if not explicitly noted in connection with a particular implementation), software (e.g., processing modules, stored instructions) and/or hardware (e.g., processor, memory devices, etc.) associated with, or included in, the computing system 400 can be configured to perform, alone, or in combination with the computing system 400, any combination of methods, functions, and/or techniques described herein. The at least one memory device can store the instructions to execute the operating system.

The computing system 400 may include at least one input/output node 420. The at least one input/output node 420 can be managed by the operating system executing on the computing system 400. The at least one input/output node 420 may receive and/or send data, such as from and/or to, a server, and/or may receive input from and provide output to a user. The input and output functions may be combined into a single node, or may be divided into separate input and output nodes. The input/output node 420 can include a microphone, a camera, an IMU, a display, a speaker, one or more buttons, and/or one or more wired or wireless interfaces for communicating with other computing devices.

Further to the descriptions above, a user may be provided with controls allowing the user to make an election as to both if and when systems, programs, or features described herein may enable collection of user information (e.g., information about a user’s browsing history, information about a user’s activities, a user’s preferences, or a user’s current location), and if the user is sent content or communications from a server. In addition, certain data may be treated in one or more ways before it is stored or used, so that personally identifiable information is removed. For example, a user’s identity may be treated so that no personally identifiable information can be determined for the user, or a user’s geographic location may be generalized where location information is obtained (such as to a city, ZIP code, or state level), so that a particular location of a user cannot be determined. Thus, the user may have control over what information is collected about the user, how that information is used, and what information is provided to the user.

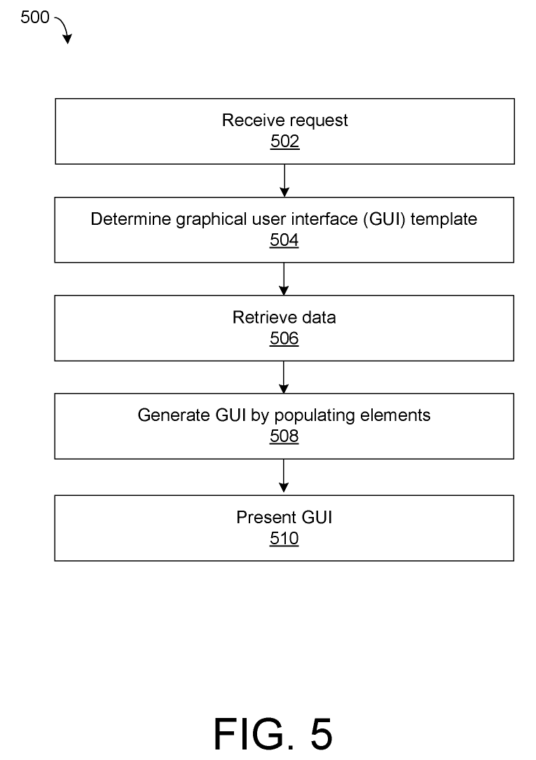

FIG. 5 is a flowchart showing a method 500 of generating a graphical user interface. The method can be performed by the computing system 400.

The method 500 includes receiving a request (502). Receiving the request (502) includes receiving a request from a user to generate a graphical user interface (GUI) for a task. The method 500 includes determining a graphical user interface (GUI) template (504). Generating the GUI template (504) can include, in response to receiving the request (502), using a model to generate a custom GUI by generating a GUI template based on the task, the GUI template including an interface element. The method 500 includes retrieving data (506). Retrieving data (506) can be performed in response to receiving the request (502). Retrieving data (506) can be included in using the model to generate the custom GUI. Retrieving data (506) can include retrieving data from a computing source. The data can be selected based on the interface element and the task. The method 500 includes generating a custom GUI by populating elements (508). Generating the custom GUI by populating the elements (508) can be performed in response to receiving the request (502). Generating the custom GUI by populating the elements (508) can include generating the custom GUI by populating the interface element of the GUI template based on the data. The method 500 can include presenting the custom GUI to the user (510).

In some implementations, the GUI is a web application running in a tab of a browser.

In some implementations, the request from the user is received via an input field implemented by an operating system executing on a computing system.

In some implementations, the custom GUI is implemented by an operating system executing on a computing system.

In some implementations, the method further includes adding a control for launching the custom GUI to a virtual workspace of an operating system executing on a computing system.

In some implementations, generating the GUI template includes selecting the GUI template from multiple potential graphical user interface templates based on the task.

In some implementations, the method 500 further includes determining, based on the task, an action associated with the interface element; receiving a selection of the interface element; and performing the action in response to the selection of the interface element.

In some implementations, the method 500 further includes deleting the custom GUI after performing the action.

In some implementations, the model includes a language model and the task is determined by the language model based on text included in the request.

In some implementations, the method 500 further includes determining the task based on text included in the request and an interaction history of the user.

In some implementations, the method 500 further includes receiving a modification request, the modification request including a request to modify the custom GUI; and modifying the custom GUI based on the GUI template and the modification request.

In some implementations, generating the GUI template includes generating the GUI template based on the task and the data.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the disclosure.

What is claimed is:

1. A method comprising:
receiving a request from a user to generate a graphical user interface (GUI) for a task;
in response to receiving the request, using a model to generate the GUI by:
determining a GUI template based on the task, the GUI template including an interface element;
retrieving data from a computing source, the data being selected based on the interface element and the task; and
generating the GUI by populating the interface element of the GUI template based on the data; and
presenting the GUI to the user.

2. The method of claim 1, wherein using the model to generate the GUI further comprises:
parsing the request to identify a task type and associated parameters;
generating a query for the computing source based on the task type and associated parameters; and
selecting the GUI template from a library of available templates based on a compatibility between the GUI template and a data type returned by the query.

3. The method of claim 1, wherein the method further includes adding a control for launching the GUI to a virtual workspace of an operating system executing on a computing system.

4. The method of claim 1, wherein generating the GUI template includes selecting the GUI template from multiple potential graphical user interface templates based on the task.

5. The method of claim 1, further comprising:
determining, based on the task, an action associated with the interface element;
receiving a selection of the interface element; and
performing the action in response to the selection of the interface element.

6. The method of claim 5, wherein performing the action includes deleting the GUI.

7. The method of claim 1, wherein the model includes a language model and the task is determined by the language model based on text included in the request.

8. The method of claim 1, further comprising determining the task based on text included in the request and an interaction history of the user, the interaction history of the user resolving ambiguity in the text included in the request.

9. The method of claim 1, further comprising:
receiving a modification request, the modification request including a request to modify the GUI;
determining a transformation based on a current state of the GUI and an intent of the modification request; and
modifying the GUI based on the transformation.

10. The method of claim 1, wherein generating the GUI template includes generating the GUI template based on the task and the data, the GUI template having interface elements that correspond to the data, the data being selected based on the task.

11. A non-transitory computer-readable storage medium comprising instructions stored thereon that, when executed by at least one processor, are configured to cause a computing system to:
receive a request from a user to generate a graphical user interface (GUI) for a task;
in response to receiving the request, use a model to generate the GUI by:
determining a GUI template based on the task, the GUI template including an interface element;
retrieving data from a computing source, the data being selected based on the interface element and the task; and
generating the GUI by populating the interface element of the GUI template based on the data; and
present the GUI to the user.

12. The non-transitory computer-readable storage medium of claim 11, wherein using the model to generate the GUI further comprises:
parsing the request to identify a task type and associated parameters;
generating a query for the computing source based on the task type and the associated parameters; and
selecting the GUI template from a library of available templates based on a compatibility between the GUI template and a data type returned by the query.

13. The non-transitory computer-readable storage medium of claim 11, wherein the instructions are further configured to cause the computing system to:
determine, based on the task, an action associated with the interface element;
receive a selection of the interface element; and
perform the action in response to the selection of the interface element.

14. The non-transitory computer-readable storage medium of claim 13, wherein performing the action includes deleting the GUI.

15. The non-transitory computer-readable storage medium of claim 11, wherein the instructions are further configured to cause the computing system to:
receive a modification request, the modification request including a request to modify the GUI;
determine a transformation based on a current state of the GUI and an intent of the modification request; and
modify the GUI based on the transformation.

16. A computing system comprising:
at least one processor; and
a non-transitory computer-readable storage medium comprising instructions stored thereon that, when executed by the at least one processor, are configured to cause the computing system to:
receive a request from a user to generate a graphical user interface (GUI) for a task;
in response to receiving the request, use a model to generate the GUI by:
determining a GUI template based on the task, the GUI template including an interface element;
retrieving data from a computing source, the data being selected based on the interface element and the task; and
generating the GUI by populating the interface element of the GUI template based on the data; and
present the GUI to the user.

17. The computing system of claim 16, wherein using the model to generate the GUI further comprises:
parsing the request to identify a task type and associated parameters;
generating a query for the computing source based on the task type and the associated parameters; and
selecting the GUI template from a library of available templates based on a compatibility between the GUI template and a data type returned by the query.

18. The computing system of claim 16, wherein the instructions are further configured to cause the computing system to:
determine, based on the task, an action associated with the interface element;
receive a selection of the interface element; and
perform the action in response to the selection of the interface element.

19. The computing system of claim 18, wherein performing the action includes deleting the GUI.

20. The computing system of claim 16, wherein the instructions are further configured to cause the computing system to:
receive a modification request, the modification request including a request to modify the GUI;
determine a transformation based on a current state of the GUI and an intent of the modification request; and
modify the GUI based on the transformation.
